(19) United States
(12) Patent Application Publication
(10) Pub. No.: US 2004/0105735 A1
(43) Pub. Date: Jun. 3, 2004

(54) Fastening element

(76) Inventors: Bernard Favre-Bulle, Vienna (AT); Mario Grazioli, Chur (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/723,154

(22) Filed: Nov. 24, 2003

(30) Foreign Application Priority Data
Nov. 26, 2002 (DE) 102 54 966.4

(51) Int. Cl. F16B 39/24

(52) U.S. Cl. 411/147

(57) ABSTRACT

A fastening element, which is designed to be set in a bore of a constructional component formed of a hard material, includes a stem (11) adjoining load application part (13), a metal washer (14) having a recess (16) formed in its end surface (15) adjacent to the free flat end surface (12) of the stem (11), and a deformable, energy dissipation element (17) arranged in the recess (16) of the metal washer (14) and projecting beyond the free flat end surface (15) of the metal washer (14) in an unsetting condition of the fastening element (16) in which the energy dissipation element (17) remains undeformed, with the recess (16) having a free lateral space (26) for accommodating the energy dissipation element (17) in its deformed condition.

### BACKGROUND OF THE INVENTION

1. Field of the Invention

The present invention relates to a fastening element to be set in a bore of a constructional component formed of a hard material and which include a load application part and the stem adjoining a load application part and having a free flat end surface.

2. Description of the Prior Art

Fastening elements of the type described above and, in particular, nails, bolts, etc. are formed of steel and are designed for fastening objects to a constructional component formed, e.g., of metal. The fastening elements include, as discussed above, a stem having a free flat end surface facing in a setting direction and a load application part such as a threaded section or a head. The driving-in or setting process is effected with, e.g., explosive power charge- or gas-operated setting tool.

German Publication DE 101 21 269A1 discloses a fastening element of the type discussed above and designed, e.g., to be driven in a pre-formed bore in a steel constructional component. The fastening element has a cylindrical stem having a cylindrical outer profile and a flat free end, and load application means. During setting of a such fastening element in a pre-formed bore in a constructional component, it is necessary to reduce an excessive setting energy, if any, e.g., of order of from 15 to 20J in order to not reduce in any noticeable way the service life of the drive piston braking device of the setting tool. Generally, for setting of such fastening elements, a smaller setting energy is required than is available in a setting tool.

German Publication DE-19 10 723 discloses a fastening element such as a nail or bolt and including a metal washer arranged on the stem and a washer formed of an elastic material and adjoining the metal washer at its end facing in a setting direction. The elastic washer serves for protecting a brittle or light material, which has to be secured to a constructional component, from a direct impact by the metal washer when a fastening element with a metal washer is driven by a setting tool. The drawback of the fastening element of DE-19 10 723 consists in that the elastic washer is arranged completely beneath the metal washer, and the play can lead to lever forces which can be applied to the load application means. The lever forces can lead to reduction of holding forces of the fastening element. If an excessive energy is applied to the fastening element, the elastic washer can be almost completely squeezed by the head of the fastening element. In this case, the recovery property of the elastic washer is very small.

Accordingly, the object of the present invention is to provide a fastening element in which the drawbacks of the conventional fastening elements are eliminated and with which an adequate cushioning of excessive energy during a setting process becomes possible.

Another object of the present invention is to provide a fastening element of the type discussed above and having good holding forces.

### SUMMARY OF THE INVENTION

These and other objects of the present invention, which will become apparent hereinafter, are achieved by providing a metal washer having a recess formed in its end surface adjacent to the free flat and surface of the stem, and a deformable energy dissipation element arranged in the recess of the metal washer and projecting beyond the free flat end surface of the metal washer in an unsetting condition of the fastening element in which the energy dissipation element is not deformed. The recess has a radial extent that is larger than the radial extent of the energy dissipation element so that a free lateral space is formed between the energy dissipation element and the radially outer surface of the recess (in the unsetting condition of the fastening element).

During a setting process with a setting tool when the fastening element is pressed into a pre-formed bore, the energy dissipation element is plastically deformed, filling the free space of the recess, whereby the excessive setting energy is absorbed. The radially outer surface of the recess limits the expansion of the energy dissipation element.

Advantageously, both the recess and the energy dissipation element have a circular cross-section. This cross-section insures a good distribution of the absorbed setting energy.

Advantageously, the energy dissipation element is formed of a plastically deformable plastic material. This permits to economically produce the energy dissipation element that, at the same time, has desired characteristics. When a sealing element in form, e.g., a sealing washer, sealing coating, and the like is provided on the bottom surface of the metal washer, the setting location becomes protected from fluid media, in particular, water, salt water, and the like.

The novel features of the present invention, which are considered as characteristic for the invention, are set forth in the appended claims. The invention itself, however, both as to its construction and its mode-of operation, together with additional advantages and objects thereof, will be best understood from the following detailed description of the preferred embodiment, when read with reference to the accompanying drawings.

### BRIEF DESCRIPTION OF THE DRAWINGS

The drawing show:

FIG. 1 a cross-sectional view of fastening element according to the present invention;

FIG. 2 a view from beneath of the fastening element shown in FIG. 1; and

FIG. 3 a cross-sectional view of the setting element shown in FIG. 1 in its set condition in a constructional component.

### DETAILED DESCRIPTION OF THE PREFERRED EMBODIMENT

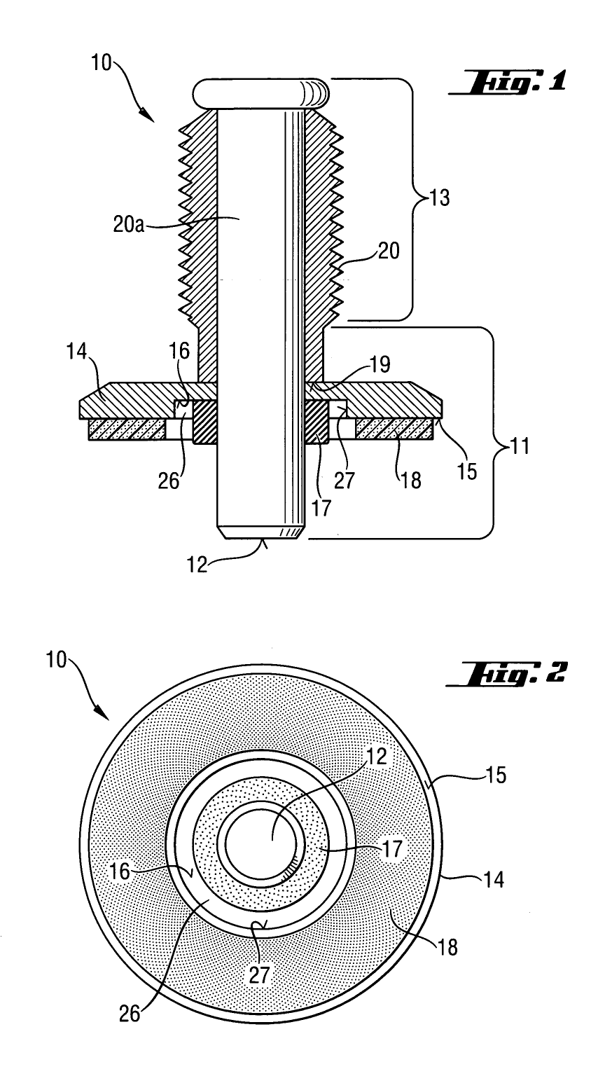

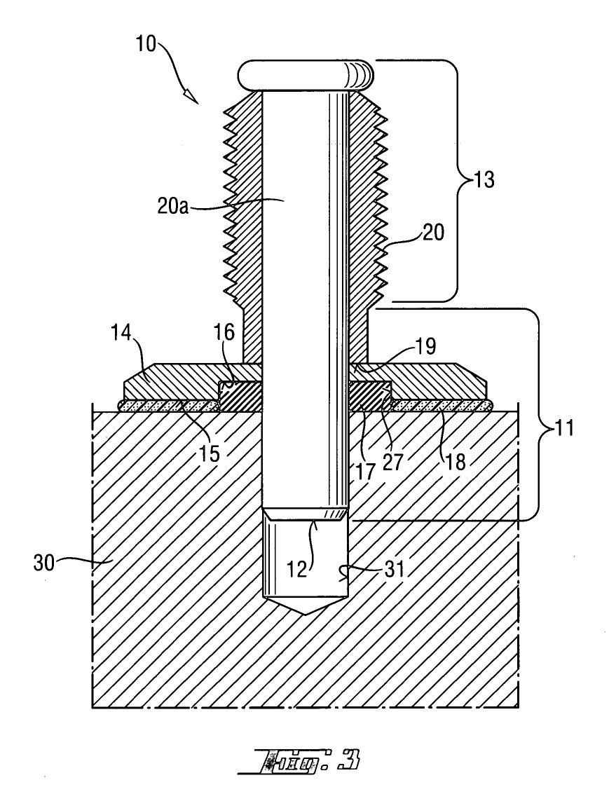

A fastening element 10 according to the present invention, which is shown in FIGS. 1-3, includes a load application part 13 that is formed in the embodiment shown in the drawings as a threaded section with a thread 20. A stem 11 adjoins the load application part 13 which, by the way, can be also formed as a thread-free nail head. In a setting direction, the first stem 11 ends with a flat end surface 12. Such fastening elements 10 are usually driven, in particular with a setting tool, in pre-formed blind bores. In the embodiment shown in the drawings, the threaded section with the thread 20 is formed as a threaded sleeve mounted or pressed on a core 20a. However, the thread 20 and the core 20a can be also formed as a one-piece member.

On the stem 11, a metal washer 14 is pinned on or pressed on. A disc-shaped sealing element 18 of a plastic material such as, e.g., neopren, is arranged on an end surface 15 of the washer 14 adjacent to the stem end surface 12. The washer 14 abuts a shoulder 19 provided on the stem 1 1.

In its region defining the end surface 15, the washer 14 has a recess 16. In the recess 16, an energy dissipation element 17 is arranged. In an unsetting condition of the fastening element 10 shown in FIG. 1, the energy dissipation element 17 projects beyond the end surface 15 of the washer 14, and the recess 16 has a free lateral space 26.

FIG. 3 shows the position of the fastening element 10 after it has been driven into a pre-formed blind bore 31. In this position of the fastening element 10, the energy dissipation element 17 is plastically deformed and is completely pressed into the recess 16 of the washer 14, having been expanded into the lateral space 26. The height of the circumferential surface 27 of the recess 16 should insure that a possible excessive setting energy would not result in the energy dissipation element 11 being pressed into the constructional component 30.

The amount of the energy dissipation is determined by the material of the energy dissipation element 17, by the size of the recess 16, and by the size of the free lateral space 26. Advantageously, the energy dissipation element 17 is formed of a plastically deformable plastic material. However, the energy dissipation element 17 can also be formed of a plastically deformable metal.

Though the present invention was shown and described with references to the preferred embodiment, such is merely illustrative of the present invention, and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A fastening element to be set in a bore of a constructional component formed of a hard material, the fastening element comprising a load application part (13); a stem (11) adjoining the load application part (13) and having a free flat end surface (12); a metal washer (14) having a recess (16) formed in an end surface (15) thereof adjacent to the free flat end surface (12) of the stem (11); and a deformable, energy dissipation element (17) arranged in the recess (16) of the metal washer (14) and projecting beyond the free flat end surface (15) of the metal washer (14) in an unsetting condition of the fastening element (10) in which the energy dissipation element (17) remains undeformed, the recess (16) having a free lateral space (26) for accommodating the energy dissipation element (17) in a deformed condition thereof.

2. A fastening element according to claim 1, wherein both the recess (16) and the energy dissipation element (17) have a circular cross-section.

3. A fastening element according to claim 1, wherein the energy dissipation element (17) is formed of plastically deformable plastic material.

4. A fastening element according to claim 1, further comprising a disc-shaped sealing element (18) arranged on the end surface (15) of the metal washer (14).
